(19) United States
(12) Patent Application Publication
(10) Pub. No.: US 2009/0186315 A1
(43) Pub. Date: Jul. 23, 2009

(54) DENTAL ARTICULATORS

(76) Inventor: Alan Julian Segal, Cheshire (GB)

Correspondence Address: GREENBLUM & BERNSTEIN, P.L.C., 1950 ROLAND CLARKE PLACE, RESTON, VA, 20191, US

(21) Appl. No.: 12/299,444

(22) PCT Filed: May 3, 2007
(86) PCT No.: PCT/GB2007/001630

§ 371 Date: Mar. 17, 2009

(30) Foreign Application Priority Data
May 4, 2006 (GB) 0608765.4

(51) Int. Cl. A61C 11/00

(52) U.S. Cl. 433/60

(57) ABSTRACT

A dental articulator has upper and lower cast models of a patient's upper and lower teeth in shells (13a, 13b) linked by an articulation joint (14). The models are formed in the shells (13a, 13b) by locating a bite tray (1, 25) having impressions on opposite sides between the shells (13a, 13b) in fixed positional relationship thereto. The lowermost shell (13a) is filled with casting material in contact with the lowermost impression and this is allowed to set to form one model. The bite tray (1, 25) and shells (13a, 13b) are then turned over to enable the other model to be formed in the other shell (13b). The bite tray (1, 25) has a projecting handle (6, 28) which is clamped with a clamping device (19) which can be detachably mounted on a base (10) both ways up. The shells (13a, 13b) can also be detachably mounted on the base (10) both ways up. Locating devices (11, 12) are provided so that the clamping devices (19) and the shells (13a, 13b) retain their positional interrelationship both ways up.

This invention relates to dental articulators.

When making a dental prosthesis for a patient, cast models of the patient's upper and lower teeth are used to aid design of the prosthesis to ensure that it will fit comfortably in the patient's mouth.

In particular, it is important to ensure that the prosthesis will not disturb the normal bite relationship between the patient's upper and lower teeth which could lead to discomfort or pain.

The cast models are made using impressions taken of the patient's teeth using impression wax on a bite tray. The models are cast from the impressions and conventionally are mounted in an articulator, by attachment of a hinged linkage to the models, which holds the cast teeth in the desired bite interrelationship whilst permitting movement of the models towards and away from each other in simulation of normal jaw movement. An arrangement of this kind is shown, by way of example, in U.S. Pat. No. 5,645,425.

To facilitate correct location of the models in the articulator, it is known to use a two-sided bite tray which takes impressions of the upper and lower teeth at the same time, thereby retaining, on the tray, the correct bite interrelationship. The tray is then used to cast the upper and lower models in upper and lower moulding shells.

In accordance with conventional practice, this is done by pouring casting material into one of the impressions which is uppermost and allowing this to set, and then turning the tray over and repeating the procedure with the other impression. One of the resulting tooth castings which is lowermost is then placed onto more casting material in one of the shells, and this is allowed to set to form a model in the shell. This procedure is then repeated for the other tooth casting to form a further model in the other shell. The two shells, with the models are then attached to the hinged linkage of the articulator.

The use of a two-sided bite tray facilitates determination of the correct positioning of the models relative to each other. However, in so far as the placing of the tooth castings into the further casting material in the shells is subject to variation, correct positioning requires exercise of skill and judgement by experienced personnel, and a high level of accuracy may be difficult or inconvenient to achieve.

Suitable two-sided bite trays are described in GB 2373448A and GB 2373449A respectively for making impressions of anterior and posterior teeth. In each case, in the practical embodiments described, the bite tray comprises a gauze insert supported within an open frame having an outwardly projecting handle. For convenience of use and to avoid or minimise cleaning requirements, these bite trays may be wholly disposable, or at least may have disposable gauze inserts.

An object of the present invention is to provide a dental articulator with which accurate location of upper and lower cast models with a desired bite interrelationship can be facilitated, whereby the need to exercise skill and judgement to achieve such accurate location can be minimised.

According to one aspect of the invention therefore there is provided a dental articulator, for making opposed cast models of upper and lower teeth, from impressions in impression material on a bite tray, comprising a pair of opposed casting shells interconnected by an articulation joint, characterised by the provision of a clamping device for clamping the bite tray between the shells in fixed position relative thereto.

With this arrangement, the clamping device can act as a jig to hold the impressions on the bite tray in fixed positions relative to the shells whilst the cast models are formed whereby a desired bite relationship between the cast models in the articulator can be readily, accurately achieved and maintained, without undue reliance on skill and judgement of expert personnel.

The arrangement can be such that the interconnected shells can be readily turned over so that each shell can be filled in turn with casting material whilst in the lowermost position. This can particularly facilitate accurate casting of models conveniently and reliably with reduced skill requirement.

Moreover, the shells, or even also the clamping device, can be readily constructed to be conveniently disposable thereby avoiding or minimising cleaning requirements.

Preferably the articulator also includes a base with a shell-locating device, each shell being removably engageable with such device. With this arrangement, the interconnected shells can be supported by or mounted on the base in opposite upright orientations, i.e. each way up.

The shell-locating device may comprise a clip or a receptacle or projection into or onto which the shell can be inserted e.g. to be frictionally gripped or simply to be located without being positively retained thereby. In one embodiment a friction-gripping device is used.

With regard to the clamping device, this may be removably or permanently attachable to the bite tray and may be disposable or reusable. The bite tray may be of the kind having an outwardly projecting handle and the clamping device may be arranged to hold the bite tray by clamping such handle.

The clamping device may be detachably engageable with the aforesaid base, the base thereby acting to establish the positional relationship between the clamping device and the shells.

The base may have at least one locating device for the clamping device with which the clamping device is detachably engageable in opposite upright orientations i.e. each way up. This may comprise a clip or receptacle or projection into or onto which opposite ends of the clamping device can be inserted or engaged e.g. to be frictionally gripped or simply to be located without being positively retained thereby.

In the case where the bite tray is asymmetrical with regard to its engagement with the clamping device, e.g. where the aforesaid handle projects asymmetrically, the base may have two spaced apart locating devices for the clamping device to accommodate the clamping device each way up, whereby opposite ends of the clamping device are engageable with different locating devices.

The clamping device may have two parts which snap fit or screw fit or otherwise positively interengage e.g. to hold the aforesaid handle or other part of the bite tray securely between such parts. Locating structures may be provided to ensure a desired angular relationship is maintained between the bite tray and the shells.

With regard to the shells, these may take any suitable form. Thus, they may comprise open troughs having a bottom wall bounded by upstanding side walls, and they may be identical or mirror images of each other.

The shells may be of any suitable shape for example corresponding to the shape of the bite tray. Thus, they may be generally rectangular or segmental or otherwise shaped.

The articulation joint may take any suitable form and thus may comprise two parts interconnected by a hinge joint.

These joint parts may be attached to the respective shells in any suitable manner. In one embodiment the joint parts are located relative to the shells e.g. by clipping or otherwise fitting over side walls of the shells, and a locking element extends from each part into the respective shell, so as to be keyed in position, thereby to lock the joint part to the shell, when the model is cast in the shell. The elements may be perforated for penetration of the model-forming material.

The articulator may be used with a bite tray of the kind described in the aforesaid patent application GB 2373448A or GB 2373449A, that is, with a bite tray of the kind having a frame which supports a bite tray insert and to which the aforesaid handle is attached.

The articulator may be specially adapted for the respective anterior and posterior bite trays described in the aforesaid patent applications whereby two different said articulators are used for anterior and posterior applications.

In accordance with a second aspect of the present invention there is provided a method of forming cast models of a patient's upper and lower teeth in an articulator so as to adopt a desired bite relationship therebetween, wherein a bite tray having impressions of such upper and lower teeth on opposite sides thereof is clamped between and in fixed position relative to first and second shells arranged lowermost and uppermost, said shells being interconnected by an articulation joint and casting material being provided in the lowermost first shell in contact with the lowermost impression on the bite tray, said casting material is allowed to set to form a first model in the lowermost first shell, the bite tray and shells are then turned over with the said fixed positional relationship between the shells and the bite tray being maintained, further casting material is provided in the lowermost second shell in contact with the impression now lowermost on the bite tray, and said further casting material is allowed to set to form a second model in the lowermost second shell.

If desired, initial casting material may be inserted into the impressions and allowed to set to form tooth castings therein prior to formation of the models in the shells.

To ensure maintenance of the desired relationship between the clamped bite tray and the shells in both orientations of the bite tray and shells, the bite tray and shells may be engaged with locating devices on a base or other structure.

The method of the second aspect of the invention may be performed using the articulator of the first aspect of the invention.

The invention will now be described further by way of example only and with reference to the accompanying drawings in which:—

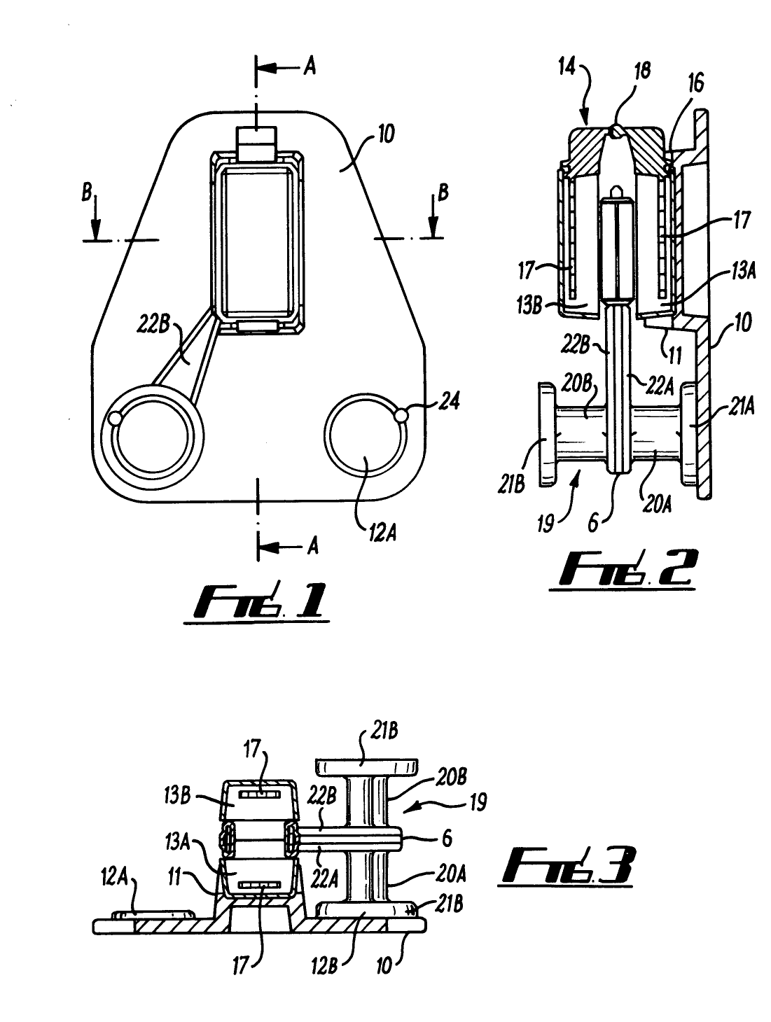

FIG. 1 is a plan view of one form of an articulator according to the invention with a posterior bite tray mounted therein;

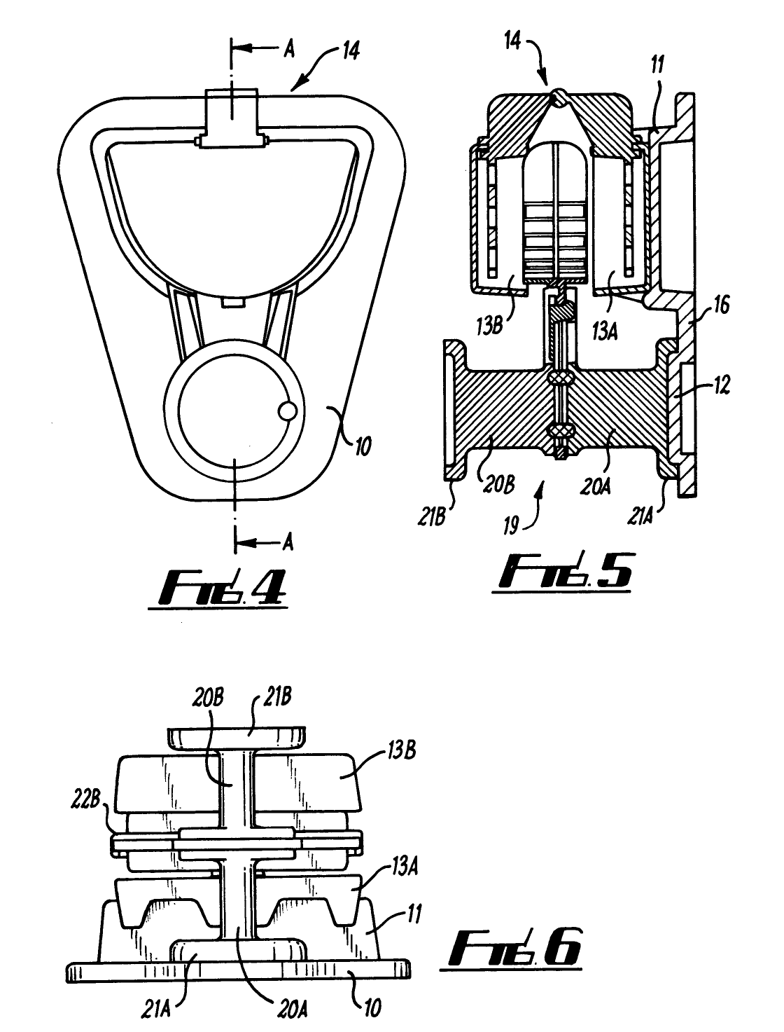

FIG. 2 is a sectional view on the line A-A of FIG. 1;

FIG. 3 is a sectional view on the line B-B of FIG. 1;

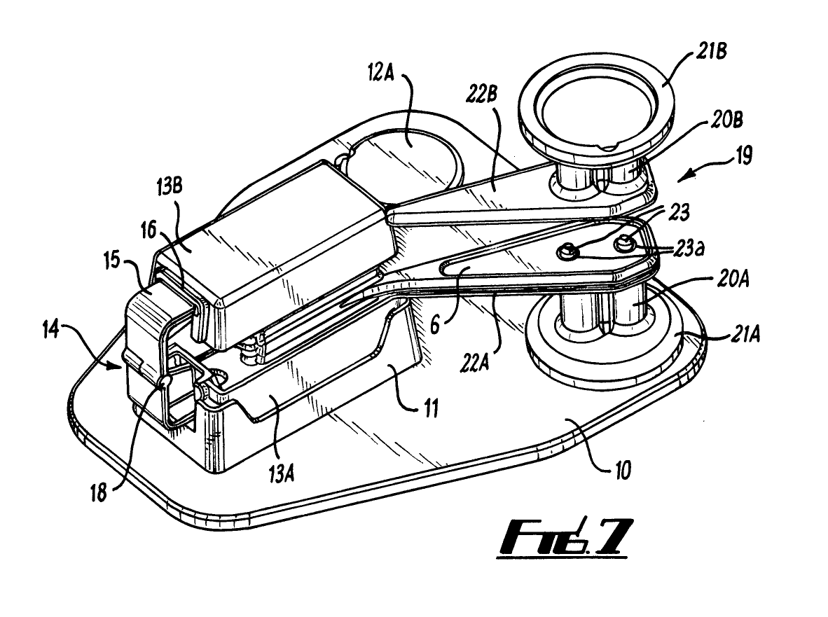

FIGS. 4-5 are views respectively corresponding to FIGS. 1-2 of an alternative embodiment with an anterior bite tray;

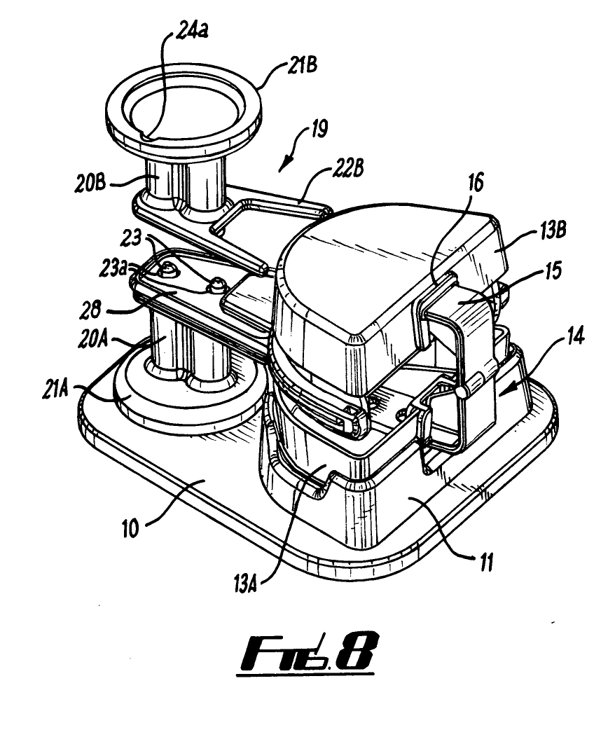

FIG. 6 is an end view of the arrangement of FIG. 4;

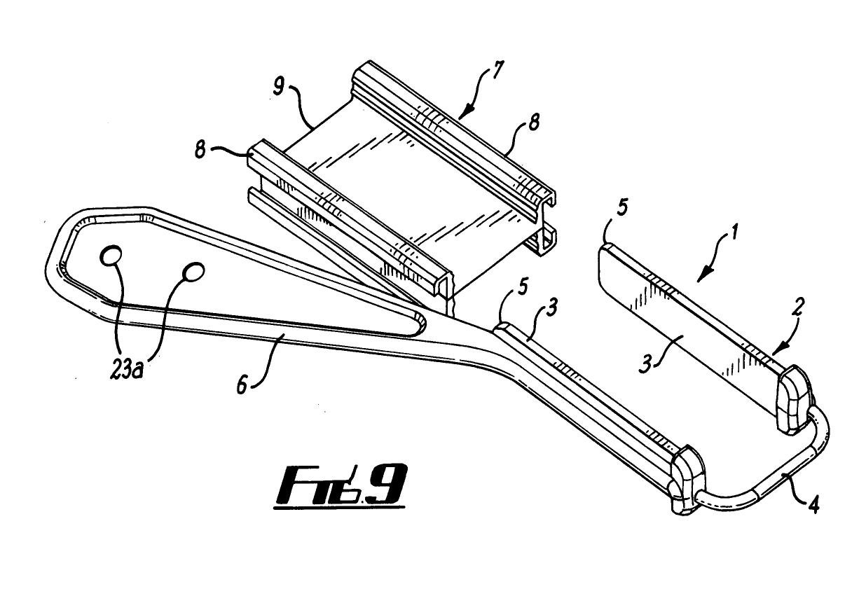

FIGS. 7 & 8 are perspective views respectively of the posterior and anterior embodiments of FIGS. 1-6.

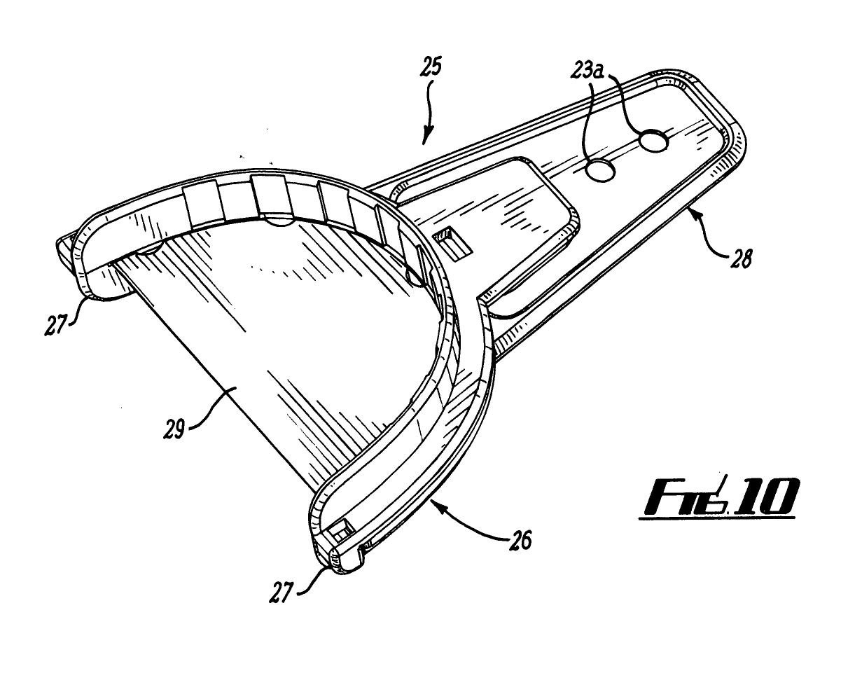

FIGS. 9 & 10 are perspective views of respectively posterior and anterior bite trays used with articulators.

Referring to FIGS. 1-3, 7 and 9 these show an articulator for use with a posterior bite tray 1.

The bite tray 1, as shown in FIG. 9, has a generally u-shaped frame 2 with parallel support arms 3 linked by a cross-arm 4 at one end.

Opposite ends 5 of the arms are open. One arm 3 at the open end 5 has an integral handle 6 which extends outwardly at an angle away from the respective arm 3.

A bite tray insert 7 is fixed between the support arms 3. The insert comprises two channel-section members 8 into which the support arms 3 can slide, and a gauze sheet 9 which is taut between the members 8 when engaged with the arms 3.

Further details are described in GB 2373449A.

The articulator comprises a flat base plate 10 which is generally of trapezoidal shape.

The base plate 10 is moulded with an upstanding rectangular open-topped receptacle 11 adjacent the narrow end of the base plate 10. The longitudinal axis of the receptacle 11 lies on the longitudinal centre line of the base plate 10.

Adjacent the opposite wider end of the base plate 10 there are moulded two like circular shallow projections 12A, B. These projections 12 are disposed symmetrically on opposite sides of the centre line of the base plate 10.

The articulator also includes two like interconnected open-topped moulding shells 13A, B.

Each shell 13 is generally rectangular with a flat bottom wall and four upstanding side walls of common height.

The shells 13 are interconnected by an articulation joint 14 so that their open tops face each other and are mutually aligned.

The articulation joint 14 comprises two moulded parts each of which has an outwardly projecting flange 15, an integral u-shaped member 16, and a forwardly projecting perforated plate 17.

The flanges 15 are linked by a hinge joint 18.

The u-shaped members 16 fit tightly over end walls of the shells 13 so that the hinge joint 18 is centred between the shells 13A, B, and the plates 17 project in parallel disposition slightly above the bottom walls of the shells 13.

The articulator also includes a clamping device 19 comprising two posts 20A, B each having a circular recessed end cap 21A, B of common size and shape at one end and a shaped transverse flat flange 22A, B at the other end.

At such other ends there are projections 23 engaging with holes 23a in the bite tray handle 6, and recesses by means of which the posts 20 can snap or otherwise fit together coaxially with the flanges 22A, B confronting each other.

Each circular end cap 21 can fit securely yet removably over each of the circular projections 12. This may be a frictional or snap fit or simply a location with limited sideways movement restrained by abutment with the projection 12.

Each shell 13 can fit securely yet removably in the rectangular receptacle 11, and again this may be a frictional or snap fit or simply a location. The side walls of the rectangular receptacle 11 are outwardly inclined to accommodate readily each shell 13.

In use, the bite tray insert 7 is charged with impression wax on both sides and is inserted into the patient's mouth to take an impression of the patient's upper and lower posterior teeth in their bite interrelationship.

The bite tray handle 6 is then securely mounted into the clamping device 19 between the flanges 22A, B and liquid casting material poured into one side of the bite tray impression. The articulator shell 13A is then fitted into the receptacle 11 and is filled with liquid casting material.

The clamping device 19 is mounted on the articulator base plate 10 by fitting one end cap 21A onto one of the circular projections 12A. The bite tray insert 7 is thus held in correct position aligned with the lower shell 13A with the lower impression wax and casting material on the bite tray insert 7 projecting into the casting material in the shell 13A.

Correct positioning is attained due to the projections 23 of the posts 20 engaging holes in the bite tray handle 6, and due to engagement of a locating recess 24a on the respective end cap 21 with a locating pin 24 on the base plate 10 alongside the projection 12A.

The casting material is then allowed to set and harden in the shell 13A.

The entire interconnected assembly of the shells 13, the bite tray 1 and the clamping device 19, is removed from the articulator base plate 10 and turned over so that the other shell 13B is now fitted into the rectangular receptacle 11.

This shell 13B is now filled with casting material, the other end cap 21B of the clamping device 19 is fitted onto the other circular projection 12B and the casting material is allowed to set and harden with the impression wax on the opposite side of the bite tray 7 within this material.

The bite tray 1 and clamping device 19 can now be removed to give models of upper and lower posterior teeth in correct bite interrelationship.

The shells 13 with the articulation joint 14 are disposable. New shells 13 and an articulation joint 14 are used to produce further models, with the same base plate 10, which enhances convenience and avoids or minimises cleansing requirements.

The clamping device 19 may be disposable or reusable, as also may be the bite tray 1.

FIGS. 4-6, 8 and 10 show a similar arrangement for use with an anterior bite tray of the kind described in GB 2373448A, and the same reference numerals are used for corresponding parts.

As shown in FIG. 10, the anterior bite tray 25 has a curved support frame 26 with free ends 27 defining an opening therebetween. A handle 28 projects outwardly from the frame in symmetrical disposition.

The frame 26 has upper and lower frame members which snap-fit together.

The bite tray has an insert 29 comprising a segmental shaped gauze sheet 30 with a mounting element fixed around its curved periphery. This element is clamped between the frame members with the straight periphery of the gauze sheet extending tautly between the free ends 27 of the frame 26.

The trapezoidal base plate 10 has the shell receptacle 11 moulded centrally adjacent the wider end and a single clamping device projection 12 moulded centrally adjacent the narrower end.

The shells 13A, 13B have a bottom wall bounded by upstanding side walls but are segmental shaped, corresponding to the shape of the bite tray insert 29.

The arrangement of FIGS. 4-6 is used in like manner to the articulator of FIGS. 1-3 except that the same locating projection 12 is used for the clamping device 19 each way up, since the handle 28 projects symmetrically for the anterior bite tray 25.

With the embodiments described above cast models can be readily constructed in a particularly simple, convenient and reliable manner. In particular, the embodiments enable use of a standardised procedure ensuring common location and positional accuracy of cast models avoiding inaccuracies due to human error, with reduced skill requirement.

It is of course to be understood that the invention is not intended to be restricted to the details of the above embodiment which are described by way of example only. Thus, for example, it is to be understood that casting material may be introduced into, and allowed to set within, the impressions, to form tooth castings, before presentation of the impressions to casting material in the shells, to form the upper and lower models.

1-12. (canceled)

13. A dental articulator, for making opposed cast models of upper and lower teeth, from impressions in impression material on a bite tray, comprising a pair of opposed casting shells interconnected by an articulation joint, wherein a clamping device is provided for clamping the bite tray between the shells in fixed position relative thereto.

14. A dental articulator according to claim 13 further comprising a base having a shell-locating device with which each said shell is removably engageable, whereby the interconnected shells are mountable on the base in opposite upright orientations.

15. A dental articulator according to claim 14 wherein the shell-locating device comprises a friction-gripping device.

16. A dental articulator according to claim 14 wherein the base has at least one locating device for the clamping device with which the clamping device is detachably engageable in opposite upright orientations.

17. A dental articulator according to claim 16 wherein the clamping device locating device comprises a projection onto which opposite ends of the clamping device can be engaged.

18. A dental articulator according to claim 16 wherein there are two spaced apart locating devices for the clamping device, for use where the bite tray is asymmetrical with regard to its engagement with the clamping device, whereby opposite ends of the clamping device are engageable with different locating devices.

19. A dental articulator according to claim 13 wherein the shells comprise open troughs.

20. A dental articulator according to claim 13 wherein the articulation joint comprises two parts interconnected by a hinge joint.

21. A dental articulator according to claim 20 wherein each part has a locking element which extends into the respective shell.

22. A dental articulator according to claim 13 in combination with a bite tray comprising a gauze insert supported within an open frame having an outwardly projecting handle, whereby the clamping device is arranged to clamp the said handle.

23. A method of forming cast models of a patient's upper and lower teeth in an articulator so as to adopt a desired bite relationship therebetween, wherein a bite tray having impressions of such upper and lower teeth on opposite sides thereof is clamped between and in fixed position relative to first and second shells arranged lowermost and uppermost, said shells being interconnected by an articulation joint and casting material being provided in the lowermost first shell in contact with the lowermost impression on the bite tray, said casting material is allowed to set to form a first model in the lowermost first shell, the bite tray and shells are then turned over with the said fixed positional relationship between the shells and the bite tray being maintained, further casting material is provided in the lowermost second shell in contact with the impression now lowermost on the bite tray, and said further casting material is allowed to set to form a second model in the lowermost second shell.
